(19) United States
(12) Patent Application Publication
(10) Pub. No.: US 2011/0072938 A1
(43) Pub. Date: Mar. 31, 2011

(54) Corkscrew

(76) Inventor: Wu-Chang Liao, Hsinchuang (TW)

(21) Appl. No.: 12/586,865

(22) Filed: Sep. 30, 2009

(51) Int. Cl. B67B 7/14; B67B 7/04

(52) U.S. Cl. 81/3.4; 81/3.45

(57) ABSTRACT

A corkscrew has a body, an extension housing, a corkscrew element and at least one pushing lever. The body is hollow and has a sleeve and a stationary housing. The extension housing is connected extendably to the stationary housing to make the length of the body extendable. The corkscrew element is mounted moveably in the body and has a grip end, a screw end and a toothed segment. The at least one pushing lever is mounted pivotally on the sleeve. Each pushing lever has a toothed end engaging the toothed segment on the corkscrew element. The corkscrew element can be moved upward several times with pivoting the at least one pushing lever and thereby extending the extension housing relative to the body to the body to provide a laborsaving effect.

### BACKGROUND OF THE INVENTION

1. Field of the Invention

The present invention relates to a corkscrew, and more particularly to a corkscrew having an extendable housing and a laborsaving capability.

2. Description of Related Art

With reference to FIG. 14, a conventional corkscrew (90) is applied for unplugging a cork on a win bottle and comprises a handle (91) and a screw (92) attached to the handle (91). When the screw (92) is screwed into the cork, the cork can be unplugged from the win bottle with a pulling force provided by a user. However, to unplug a cork with the conventional corkscrew (90) needs a large pulling force, so the use of the conventional corkscrew is inconvenient and laborious.

With reference to FIG. 15, another conventional corkscrew comprises a hollow body (80), a corkscrew element (81) and two pushing levers (82). The corkscrew element (81) is mounted moveably in the body (80) and has a grip end, a screw end (812) and a toothed segment (811). The pushing levers (82) are mounted pivotally on the body (10) and each has a toothed end engaging the toothed segment (811) on the corkscrew element (81).

To unplug a cork from a bottle, the screw end (812) of the corkscrew element (81) is screwed into the cork by rotating the corkscrew element (81) with the grip end. When the corkscrew element (81) is rotated, the pushing levers (82) are pivoted upward relative to the body (80) and the bottom of the body (80) abutting with the top of the bottle. Then, the pushing levers (82) are pushed downward to move the corkscrew element (81) upward relative to the body (80). Consequently, the cork can be lifted and moved upward relative to and unplug from the bottle.

However, the body (80) of the conventional corkscrew has a fixing and unextendable length, so the movement distance of the corkscrew element (81) and the unplugging travel of the cork are fixed. Therefore, the cork may not be unplugged in a single travel, a pulling force is still needed to unplug the cork from the bottle. The conventional corkscrew is also inconvenient and laborious in use.

To overcome the shortcomings, the present invention tends to provide a corkscrew to mitigate or obviate the aforementioned problems.

### SUMMARY OF THE INVENTION

The main objective of the invention is to provide a corkscrew having an extendable length and a laborsaving capability. The corkscrew comprises a body, an extension housing, a corkscrew element and at least one pushing lever. The body is hollow and has a sleeve and a stationary housing. The sleeve has a bottom end. The stationary housing is formed on and protrudes from the bottom end of the sleeve. The extension housing is connected extendably to the stationary housing. The corkscrew element is mounted moveably in the body and comprises a grip end, a screw end and a toothed segment. The grip end is provided with a grip and extends out from the sleeve of the body. The screw end is opposite to the grip end. The toothed segment is formed between the grip end and the screw end and is mounted moveably in the sleeve of the body. The at least one pushing lever is mounted pivotally on the sleeve of the body. Each pushing lever has a toothed end mounted through the sleeve and engaging the toothed segment on the corkscrew element. Accordingly, the corkscrew element can be moved upward several times with extending the extension housing relative to the body, such that a laborsaving effect is provided.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a corkscrew in accordance with the present invention;

FIG. 2 is an exploded perspective view of the corkscrew in FIG. 1;

FIG. 3 is a side view in partial section of the corkscrew in FIG. 1;

FIG. 4 is a perspective view of a second embodiment of a corkscrew in accordance with the present invention;

FIG. 5 is an exploded side view in partial section of a body of a third embodiment of a corkscrew in accordance with the present invention;

FIG. 6 is an exploded perspective view in partial section of a body of a fourth embodiment of a corkscrew in accordance with the present invention;

FIGS. 7 to 13 are operational side views in partial section of the corkscrew in FIG. 1 showing the process of unplugging a cork from a bottle;

FIG. 14 is a side view of a first conventional corkscrew in accordance with the prior art; and

FIG. 15 is a perspective view of a second conventional corkscrew in accordance with the prior art.

### DETAILED DESCRIPTION OF PREFERRED EMBODIMENT

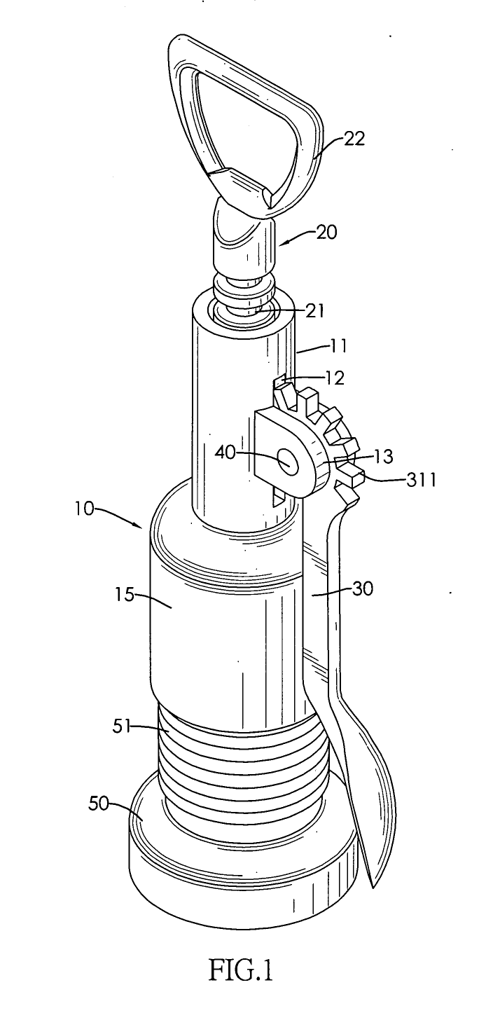

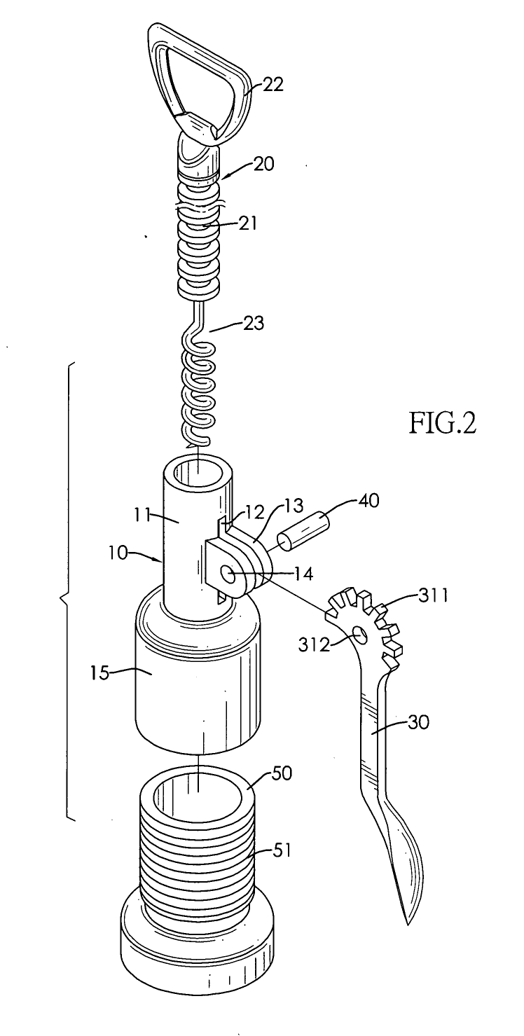

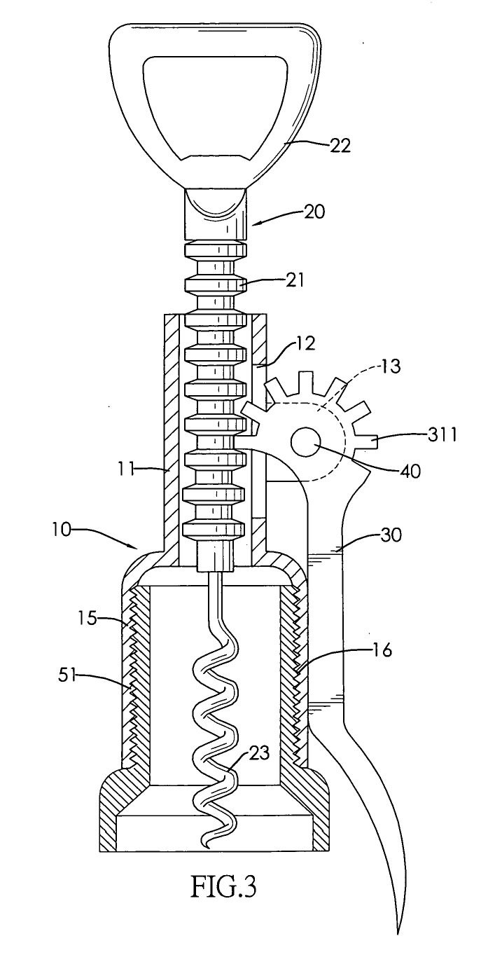

With reference to FIGS. 1 to 3, a corkscrew in accordance with the present invention comprises a body (10), an extension housing (50), a corkscrew element (20) and at least one pushing lever (30).

The body (10) is hollow and comprises a sleeve (11) and a stationary housing (15). The sleeve (11) has a bottom end, an outer surface, at least one slot (12) and at least one pair of pivotal tabs (13). The at least one slot (12) is defined longitudinally through the outer surface of the sleeve (11). The at least one pair of pivotal tabs (13) is formed on and protrudes from the sleeve (11) respectively at two sides of the at least one slot (12). Each pivotal tab (13) has a pivotal hole (14) defined through the pivotal tab (13) and aligning the pivotal hole (14) on the other pivotal tab (13).

The stationary housing (15) is formed on and protrudes from the bottom end of the sleeve (11) and has a diameter larger than that of the sleeve (11).

The extension housing (50) is connected extendably to the stationary housing (15). In the first embodiment, the stationary housing (15) and the extension housing (50) are connected with each other with threads. Preferably, the stationary housing (15) has an inner thread (16) formed in the extension housing (15), and the extension housing (50) has an outer thread (51) formed on the extension housing (50) and screwed with the inner thread (16) in the stationary housing (15). With the engagement of the threads (16, 51) on the housings (15,50), the length of the body (10) is extendable by rotating the extension housing (50) relative to the stationary housing (15).

The corkscrew element (20) is mounted moveably in the body (10) and comprises a grip end (22), a screw end (23) and a toothed segment (21). The grip end (22) is provided with a grip and extends out from the sleeve (11) of the body (10). The screw end (23) is opposite to the grip end (22). The toothed segment (21) is formed between the grip end (22) and the screw end (23), may have multiple teeth or be threaded and is mounted moveably in the sleeve (11) of the body (10).

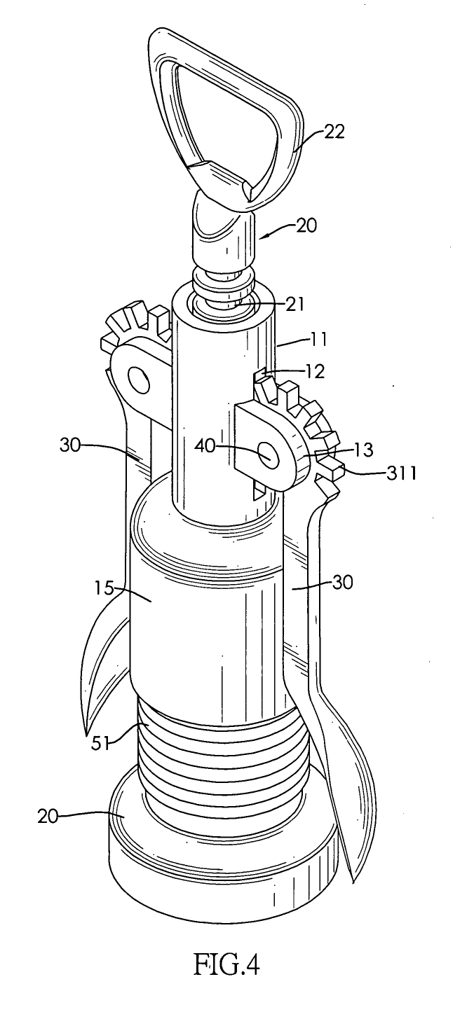

The at least one pushing lever (30) is mounted pivotally on the sleeve (11) of the body (10). In the first embodiment, the corkscrew has a single pushing lever (30). In the second embodiment as shown in FIG. 4, the corkscrew has two pushing levers (30). Each pushing lever (30) has a toothed end (311), a pivotal hole (312) and a pivot (40). The toothed end (311) is mounted through one of the slots (12) in the sleeve (11) and has multiple teeth engaging the toothed segment (21) on the corkscrew element (20). With the engagement between teeth on the tooth end (311) and the toothed segment (21), the corkscrew element (20) can be moved upward or downward when the pushing lever (30) is pivoted relative to the body (10). The pivotal hole (312) is defined through the toothed end (311) of the pushing lever (30) and aligns with the pivotal holes (14) in a corresponding pair of pivotal tabs (13). The pivot (40) is mounted through the pivotal holes (14, 312) in the corresponding pair of pivotal tabs (13) and the pushing lever (30) to pivotally connect the pushing lever (30) onto the sleeve (11).

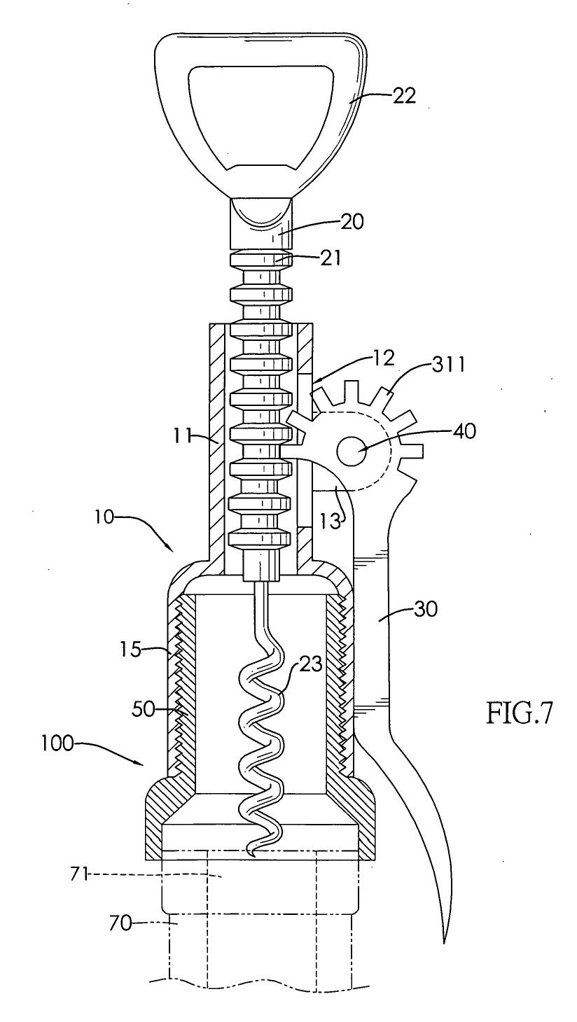

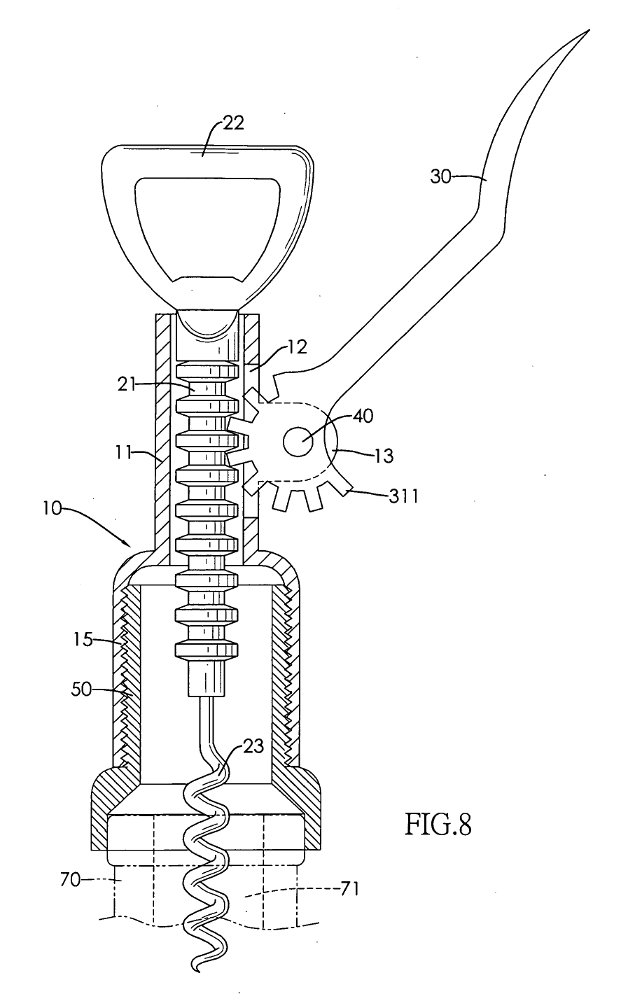

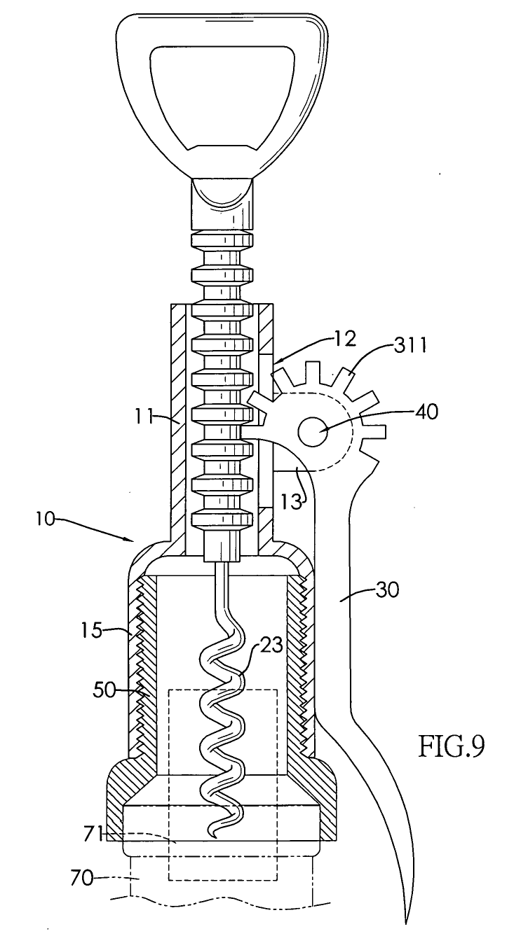

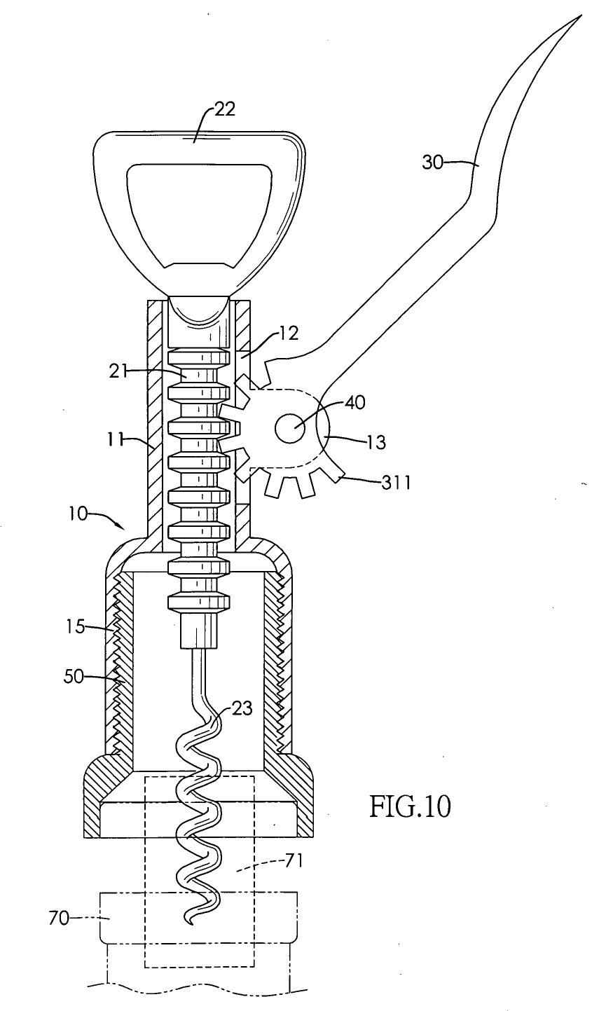

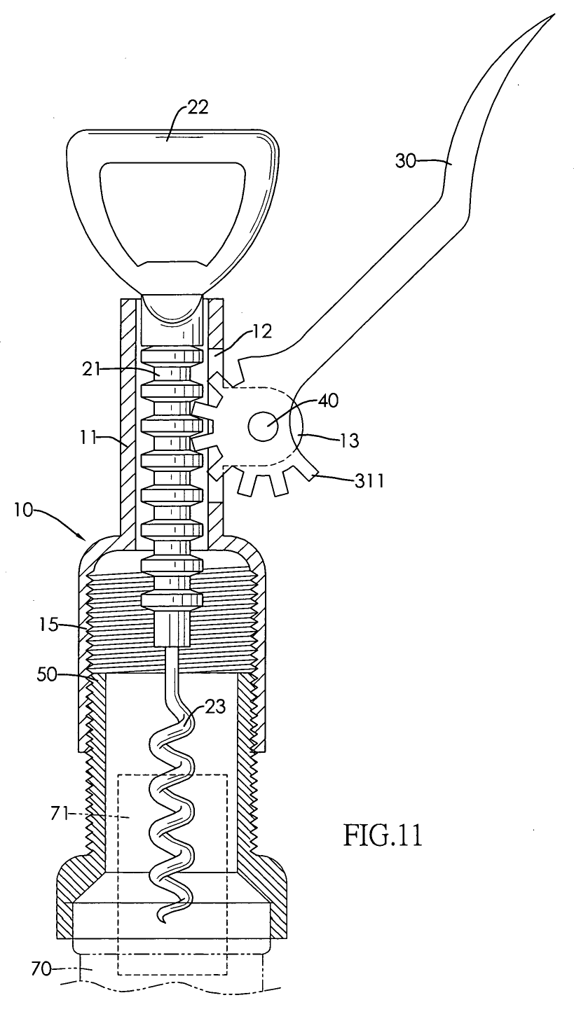

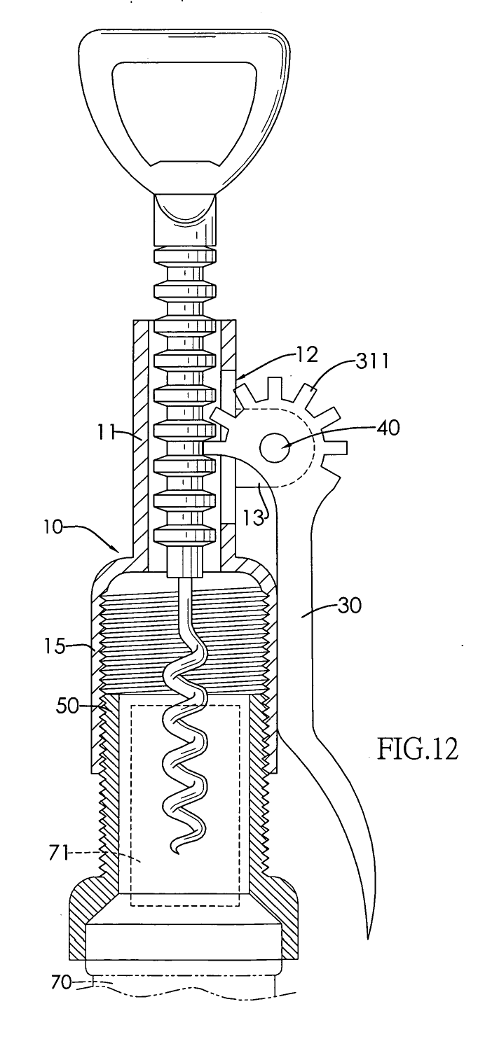

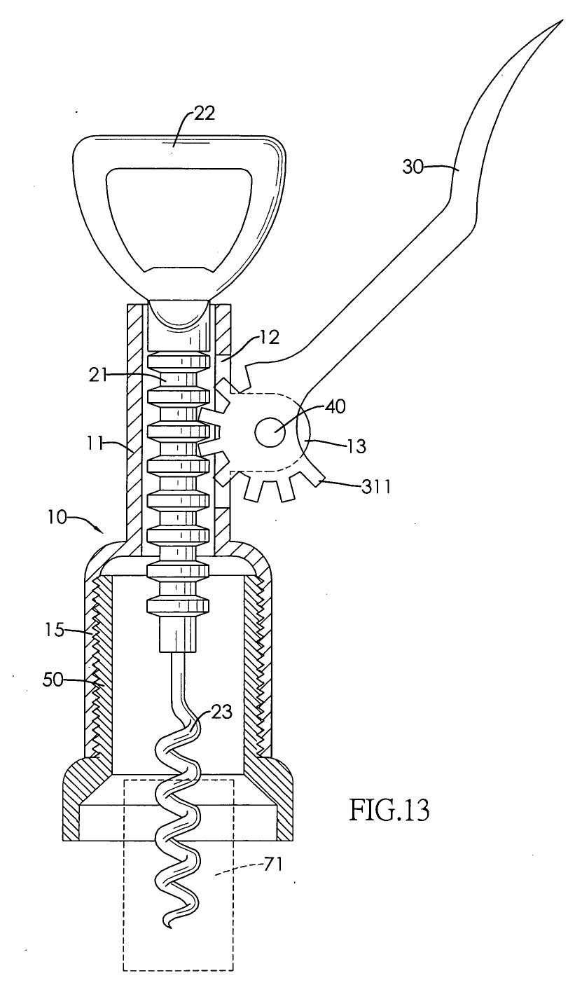

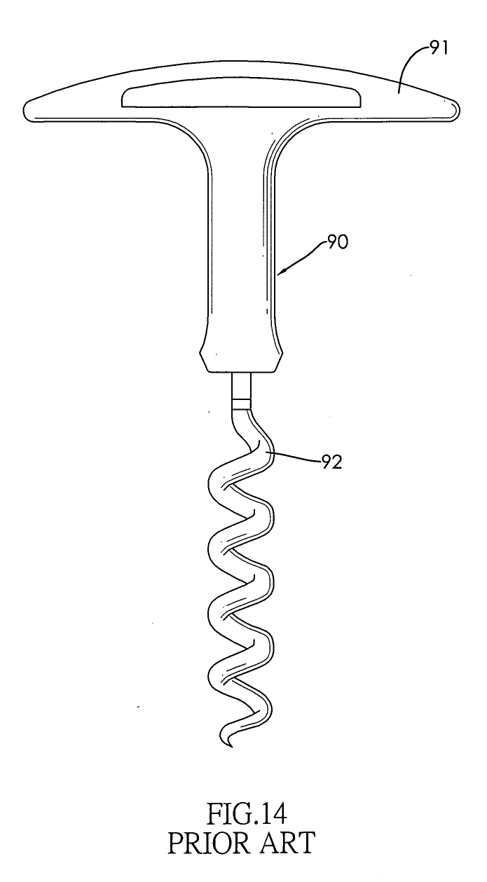

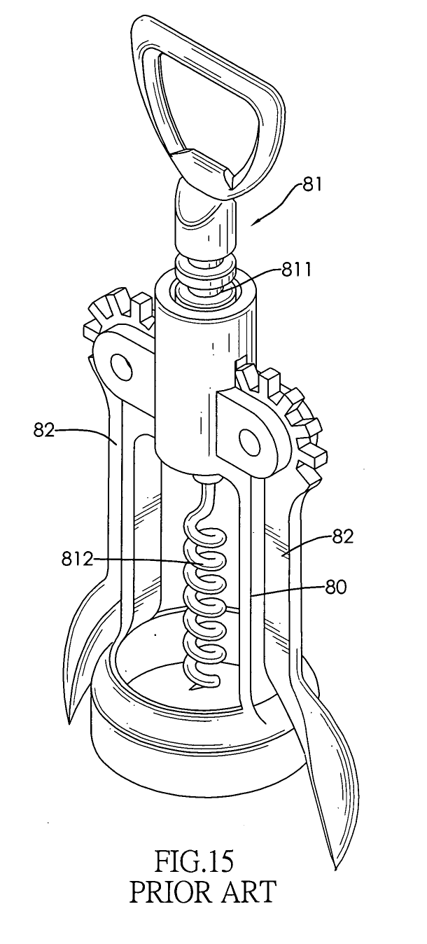

To unplug a cork (71) from a win bottle (70), with reference to FIGS. 7 to 13, the screw end (23) is screwed into the cork (71) by rotating the corkscrew element (20) until the bottom of the extension housing (50) abutting with the top of the bottle (70). At this time, the pushing lever (30) is pivoted upward to a highest position as shown in FIG. 8 by the toothed segment (21) of the corkscrew element (20). The pushing lever (30) is then pushed to pivot downward, and the corkscrew element (20) can be moved upward relative to the body (10) with the engagement of the teeth on the toothed segment (21) of the corkscrew element (20) and the toothed end (311) of the pushing lever (30). Consequently, the cork (71) can be moved upward relative to the bottle (70) by the corkscrew element (20). If the cork (71) is not unplugged completely from the bottle (70), the pushing lever (30) is pivoted upward relative to the body (10) as shown in FIG. 10. With the pivotal rotation of the pushing lever (30), the body (10) will be lifted to make the bottom of the extension housing (50) away from the top of the bottle (70). The extension housing (50) is then rotated to extend from the stationary housing (15) until the bottom of the extension housing (50) abutting with the top of the bottle (70) as shown in FIG. 11. Consequently, the pushing lever (30) is then pivoted downward to lift the corkscrew element (20) and the cork (71). Therefore, the steps shown in FIGS. 10 to 12 can be operated repeatedly until the cork (71) being unplugged from the bottle (70) completely. After the extension housing (50) being retracted into the stationary housing (15), the pushing lever (30) can be pivoted upward to move the corkscrew element (20) downward with the engagement between the toothed end (311) and the toothed segment (21). Accordingly, the cork (71) is exposed from the extension housing (50) and can be easily detached from the screw end (23) of the corkscrew element (20) by rotating the cork (71).

Accordingly, a pulling force is unnecessary during the process of unplugging a cork (71) from a bottle (70) with the corkscrew in accordance with the present, so the use of the corkscrew is convenient and laborsaving. A person, even a woman or a child can unplug the cork (71) from a bottle (70) easily.

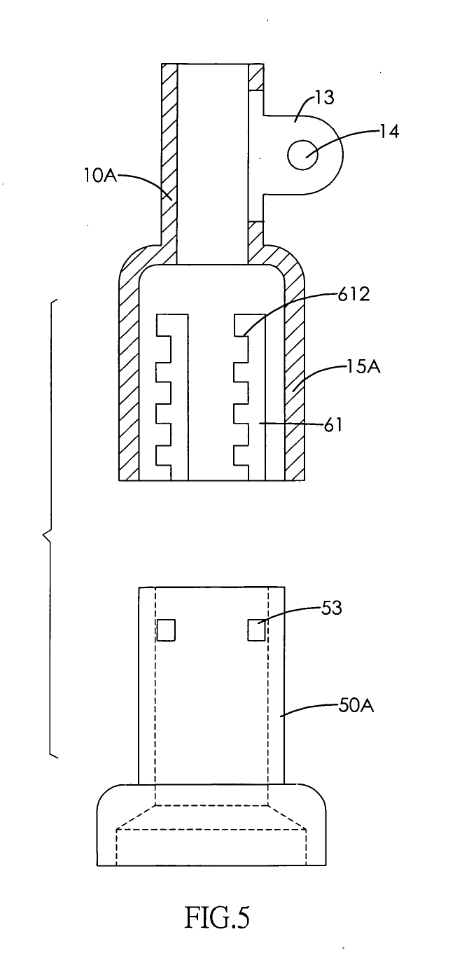

With reference to FIG. 5, in the third embodiment, the stationary housing (15A) has multiple adjusting channels (61) formed longitudinally in the inner surface of the stationary housing (15A). Each adjusting channel (61) has multiple positioning cavities (612) formed in one side of and communicating with the adjusting channel (61). The extension housing (50A) has multiple positioning knobs (53) formed on and protruding from the extension housing (50A) and respectively mounted slidably in the adjusting channels (61). Each positioning knob (53) selectively engages one of the positioning cavities (612) in a corresponding adjusting channel (61). With the engagements between the positioning knobs (53) and the positioning cavities (612), the extension housing (50A) is held at position relative to the stationary housing (15A) to make the body (10A) having a length. After the extension housing (50A) is rotated to make the positioning knobs (53) disengaging from the corresponding positioning cavities (612), the extension housing (50A) can be slid relative to the stationary housing (15A) along the adjusting channels (61) to adjust and extend the length of the body (10A). After the extension housing (50A) is rotated in reverse to make the positioning knobs (53) engaging another corresponding positioning cavities (612), the extension housing (50A) is held at the extension position relative to the stationary housing (15A).

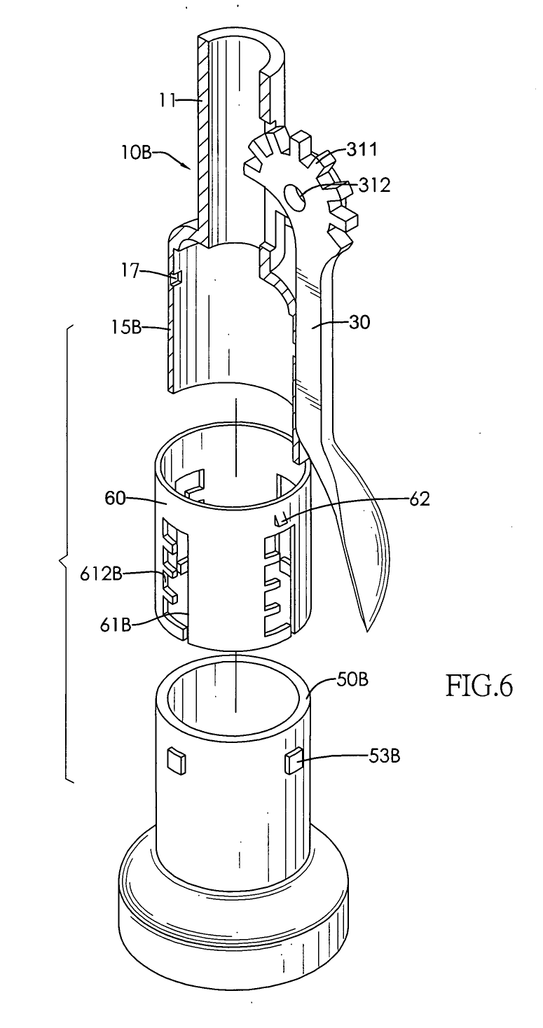

With reference to FIG. 6, in the fourth embodiment, the body (10B) further has a lining housing (60) mounted in the stationary housing (15B) and having multiple adjusting channels (61B). The adjusting channels (61B) are formed longitudinally through the lining housing (60), and each adjusting channel (61B) has multiple positioning cavities (612B) formed in one side of and communicating with the adjusting channel (61B). To mount the lining housing (60) in the stationary housing (15B), the stationary housing (15B) has multiple engaging holes (17) defined in the inner surface of the stationary housing (15B). The lining housing (60) has multiple engaging protrusions (62) formed on and protruding from the lining housing (60) and respectively engaging the engaging holes (17) in the stationary housing (15B). In an alternative embodiment, the lining housing (60) and the stationary housing (15B) are combined securely with each other by glue, fasteners or high frequency combining technique.

The extension housing (50B) has multiple positioning knobs (53B) formed on and protruding from the extension housing (50B), respectively mounted slidably in the adjusting channels (61B) in the lining housing (60) and each selectively engaging one of the positioning cavities (612B) in a corresponding adjusting channel (61B). The extension operation of the extension housing (50B) in the fourth embodiment is same as that of the extension housing (50A) in the third embodiment shown in FIG. 5, so the detail description of the operation is omitted.

What is claimed is:

1. A corkscrew comprising:
a hollow body comprising
a sleeve having a bottom end;
at least one slot defined longitudinally through the sleeve; and
at least one pair of pivotal tabs formed on and protruding from the sleeve respectively at two sides of the at least one slot, each pivotal tab having a pivotal hole defined through the pivotal tab; and
a stationary housing formed on and protruding from the bottom end of the sleeve;
an extension housing connected extendably to the stationary housing;
a corkscrew element mounted moveably in the body and comprising
a grip end provided with a grip and extending out from the sleeve of the body;
a screw end opposite to the grip end;
a toothed segment formed between the grip end and the screw end and mounted moveably in the sleeve of the body; and
at least one pushing lever mounted pivotally on the sleeve of the body, and each one of the at least one pushing lever having a toothed end mounted through the sleeve and engaging the toothed segment on the corkscrew element, and each one of the at least one pushing lever having
a pivotal hole defined through the toothed end of the pushing lever and aligning with the pivotal holes in a corresponding pair of pivotal tabs; and
a pivot mounted through the pivotal holes in the corresponding pair of pivotal tabs and the pushing lever,
whereby the corkscrew element can be moved upward several times with pivoting the at least one pushing lever and extending the extension housing relative to the body to provide a laborsaving effect.

2. The corkscrew as claimed in claim 1, wherein the stationary housing and the extension housing are connected with each other with threads.

3. The corkscrew as claimed in claim 2, wherein
the stationary housing has an inner thread formed in the stationary housing; and
the extension housing has an outer thread formed on the extension housing and screwed with the inner thread in the stationary housing.

4. The corkscrew as claimed in claim 1, wherein
the stationary housing has multiple adjusting channels formed longitudinally in an inner surface of the stationary housing and each adjusting channel having multiple positioning cavities formed in one side of and communicating with the adjusting channel; and
the extension housing has multiple positioning knobs formed on and protruding from the extension housing, respectively mounted slidably in the adjusting channels and each selectively engaging one of the positioning cavities in a corresponding adjusting channel.

5. The corkscrew as claimed in claim 1, wherein
the body further has a lining housing mounted in the stationary housing and having multiple adjusting channels formed longitudinally through the lining housing and each adjusting channel having multiple positioning cavities formed in one side of and communicating with the adjusting channel; and
the extension housing has multiple positioning knobs formed on and protruding from the extension housing, respectively mounted slidably in the adjusting channels in the lining housing and each selectively engaging one of the positioning cavities in a corresponding adjusting channel.

6. The corkscrew as claimed in claim 5, wherein
the stationary housing has multiple engaging holes defined in an inner surface of the stationary housing; and
the lining housing further has multiple engaging protrusions formed on and protruding from the lining housing and respectively engaging the engaging holes in the stationary housing.

7. The corkscrew as claimed in claim 5, wherein the lining housing and the stationary housing are combined securely with each other by glue.

8. The corkscrew as claimed in claim 5, wherein the lining housing and the stationary housing are combined securely with each other by fasteners.

9. The corkscrew as claimed in claim 5, wherein the lining housing and the stationary housing are combined securely with each other by high frequency combing technique.
